(19) United States
(12) Patent Application Publication
(10) Pub. No.: US 2018/0064164 A1
(43) Pub. Date: Mar. 8, 2018

(54) Device and Means fro Removably Attaching a Cigar to a Magnetically Attractable Object

(71) Applicants: Darrell Wade Wilkerson, Arlington, TX (US); Mark Alan VanMeter, Arlington, TX (US)

(72) Inventors: Darrell Wade Wilkerson, Arlington, TX (US); Mark Alan VanMeter, Arlington, TX (US)

(21) Appl. No.: 15/259,051

(22) Filed: Sep. 8, 2016

(51) Int. Cl. A24F 13/22; A24F 13/08; F16B 1/00

(52) U.S. Cl. CPC A24F 13/22; F16B 2001/0035; F16B 1/00; A24F 13/08

(57) ABSTRACT

A removably attachable device for removably attaching a cigar to a magnetically attractable object is disclosed. In one embodiment, the device utilizes a plurality of magnetically attractable members for removably attaching the device to the cigar and for removably attaching the cigar to a magnetically attractable object. In one embodiment, the device consists of a conformable, band-like member with a plurality of magnetically attractable members secured to the conformable, band-like member, the magnetically attractable members having the spacing such that when the conformable, band-like member is conformed around the circumference of a cigar, the magnetically attractable members are positioned relative to one another such that they are pulled towards each other through their magnetic attraction to one another, causing the conformable, band-like member to impart a securing force around the circumference of the cigar, thus securing the cigar. Spacing of the plurality of magnetically attractable members is varied to provide varying force to be imparted on the circumference of the cigar providing for varying fits of the conformable band-like member around the circumference of the cigar and providing the ability to accommodate varying cigar diameters.

When two magnetically attractable objects are brought within close proximity to one another, they are magnetically attracted to each other and will removably attach to one another. The orientation of magnetically attractable objects with respect to one another is specific and repeatable. If each magnetically attractable object is a magnet, the north pole of one magnet is attracted to the south pole of another magnet and the centers of the magnetic poles tend towards alignment with one another. This results in the magnetic attraction between the magnets tending to cause the magnets to center on one another such that the poles are aligned. When the magnets are positioned such that the north face of one magnet is placed in contact with or in close proximity to the south face of another magnet such that the magnetic poles are parallel to one another and are oriented off-center relative to one another, the magnetically attractable force between the magnets pulls the magnets towards each other to a centering position that tends to align the magnetic poles along a common centerline. In one embodiment the current invention utilizes this phenomena to act as a magnetic spring force that provides tension in the conformable band-like member that is conformed around the circumference of the cigar imparting a retaining force on the cigar and securing the cigar within the conformable band-like member. Once the cigar is secured within the conformable, band-like member by the plurality of magnetically attractable members, the plurality of magnetically attractable members additionally provide for removably attaching the cigar to a magnetically attractable object.

### BACKGROUND OF THE INVENTION

Most cigar smokers prefer to smoke their cigars at a leisurely pace and take the time to thoroughly enjoy the cigar smoking experience. It is not uncommon for the cigar smoker to want or need to put down the cigar during the experience. Additionally, it is common for cigar smokers to enjoy smoking their cigars while participating in an activity that requires them to put down the cigar, such as playing golf. When a cigar smoker needs or chooses to put down their cigar, it is often difficult to find an appropriate location to place the cigar that is sanitary, safe, secure, and free of potential risks, problems, or other unwanted hazards.

The present invention provides for a device and means for retaining a cigar, allowing the cigar smoker to safely and securely retain the cigar in an appropriate location that is sanitary, safe, secure, and free of potential risks, problems, and other unwanted hazards.

### SUMMARY OF THE INVENTION

One object of the present invention is to provide a new and improved method and device for removably attaching a cigar to a magnetically attractable object. One embodiment of the present invention consists of a conformable member and a plurality of magnetically attractable members arranged such that the conformable member can be placed around the circumference of a cigar for the purpose of securing the cigar to a magnetically attractable object. The conformable member, by its material, design and/or construction, is conformable to the circumference of a cigar and is securable around the circumference of the cigar by the magnetic attraction between the plurality of magnetically attractable members. The securing force imparted on the cigar by the conformable member is a function of the relative position of the plurality of magnetically attractable members to one another when the conformable member is conformed to the cigar's circumference. The securing force imparted on the cigar by the conformable member is also a function of the conformable member's material, design and/or construction.

### DETAILED DESCRIPTION

Referring now to the figures wherein reference numbers and the components they designate are consistently held throughout the figures.

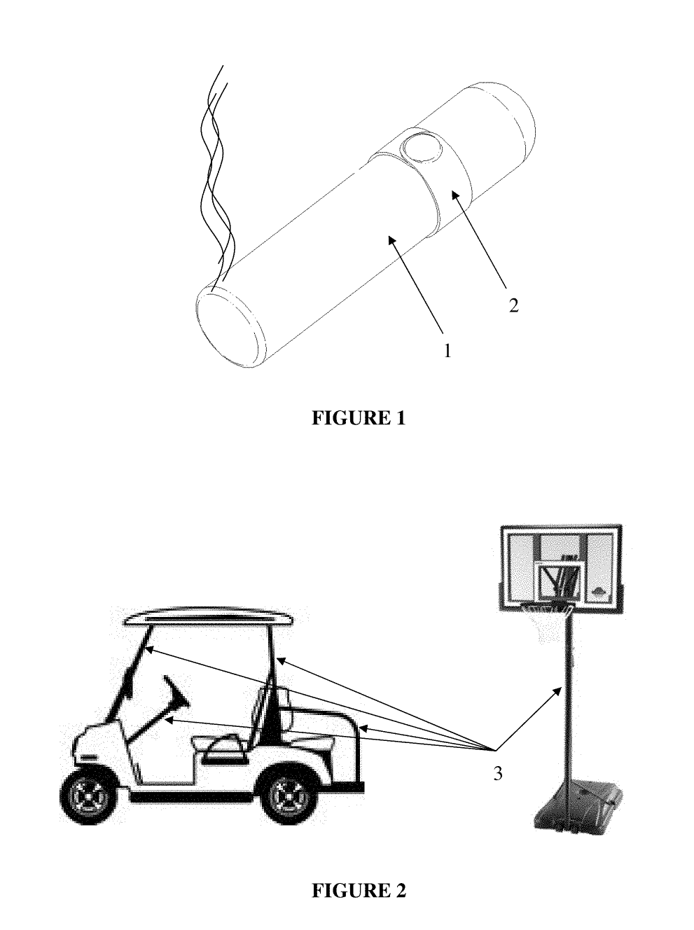

Referring now to FIG. 1 that shows a typical cigar (1) with one embodiment of the present invention (2) removably attached around its circumference.

Referring now to FIG. 2 that shows examples of magnetically attractable objects (3) not part of the present invention. Many other examples of magnetically attractable objects exist and are not illustrated here.

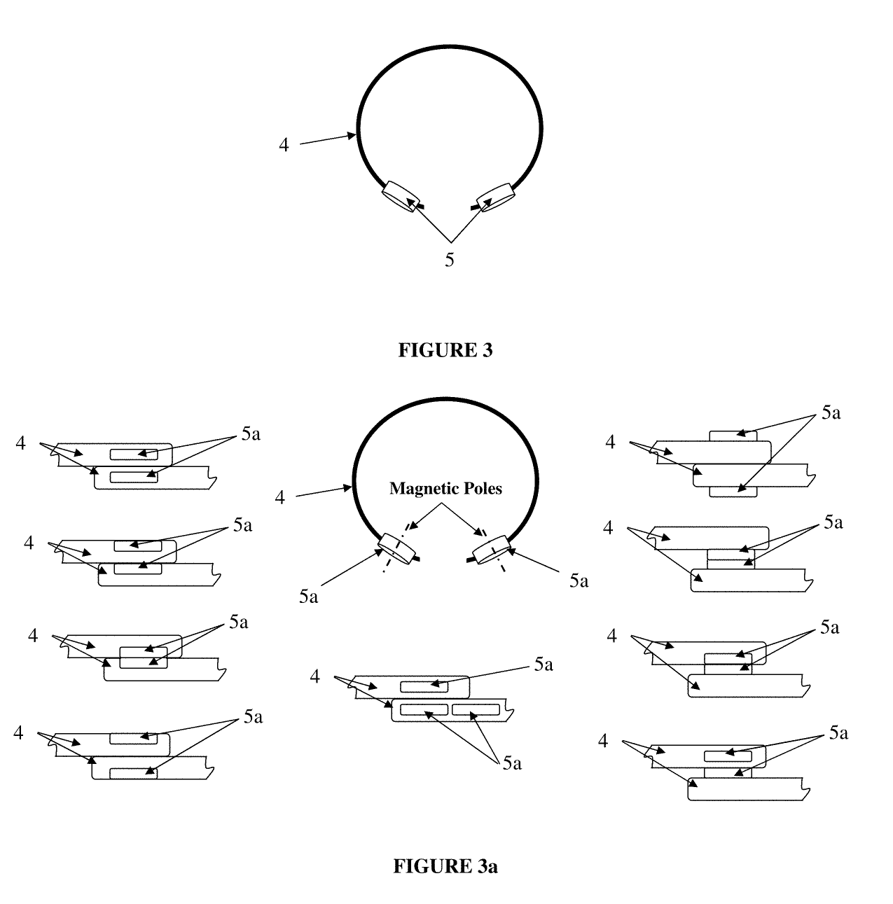

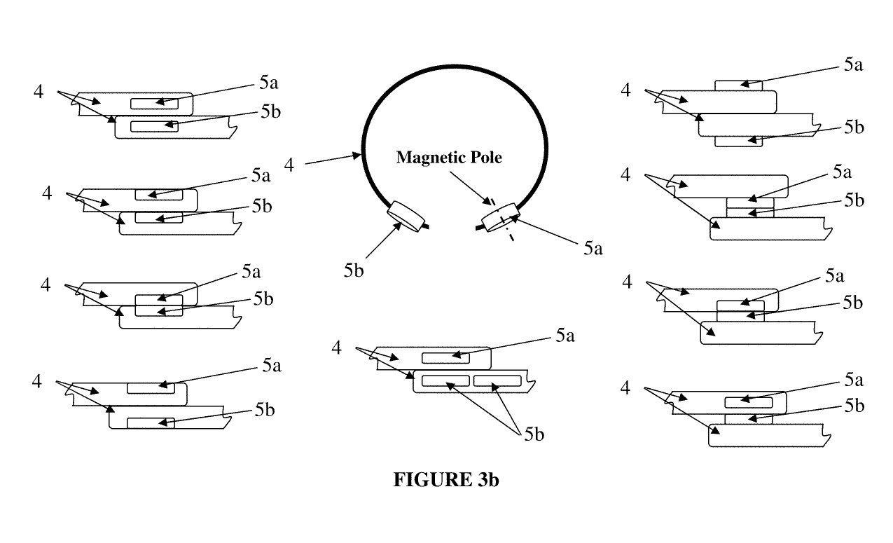

Referring now to FIG. 3 that shows one embodiment of the present invention having conformable member (4), and a plurality of magnetically attractable members (5).

Referring now to FIG. 3a that shows one embodiment of the present invention having conformable member (4), and a plurality of magnetically attractable members, each of which is a magnet (5a). Referring still to FIG. 3a that additionally shows multiple examples of potential configurations of the embodiment but does not show all potential configurations of the embodiment.

Referring now to FIG. 3b that shows one embodiment of the present invention having conformable member (4) and a plurality of magnetically attractable members, at least one of which is a magnet (5a) and at least one of which is not a magnet (5b). Referring still to FIG. 3b that additionally shows multiple examples of potential configurations of the embodiment but does not show all potential configurations of the embodiment.

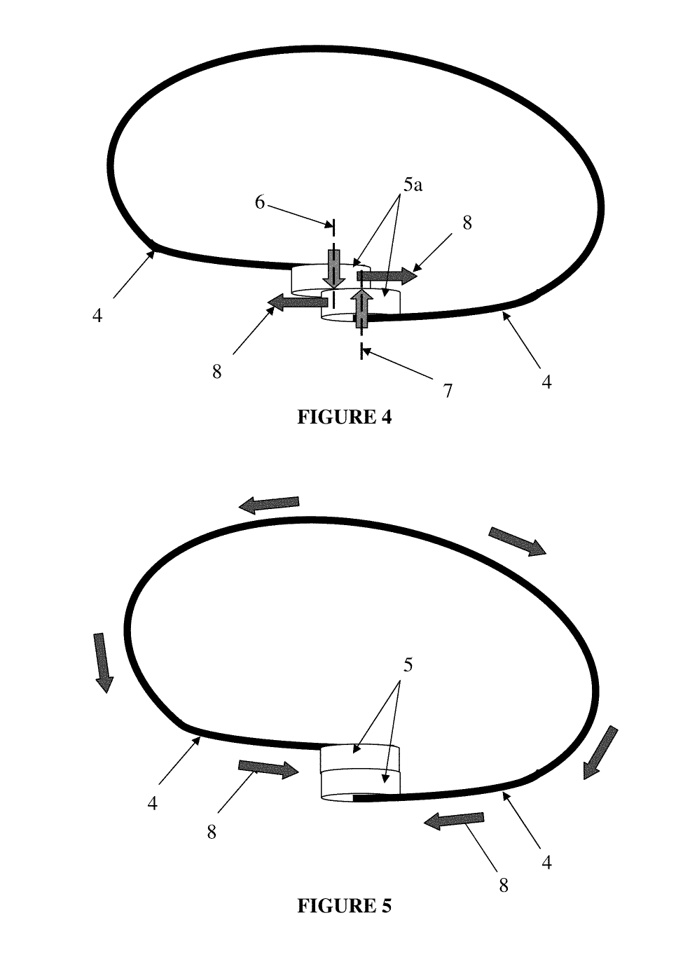

Referring now to FIG. 4 that shows one embodiment of the present invention with a plurality of magnetically attractable members (5a), each of which is a magnet, in proximity relative to one another such that they provide a spring-like tensioning force to be imparted on the cigar (1) by the conformable member (4). Referring still to FIG. 4 that shows the proximity of magnetic pole (6) to the proximity of magnetic pole (7) of the magnet members (5a). Referring still to FIG. 4 that shows the direction of the spring-like magnetic force (8) imparted on the conformable member (4) due to the magnetic pole (6) and the magnetic pole (7) tending to align with one another due to their magnetic attraction.

Referring now to FIG. 5 that shows one embodiment of the present invention having a conformable member (4) made from a material having a spring-rate or that by its material, design and/or construction has a spring-rate such that as the material is pulled in tension to elongate and/or induce strain, the conformable member (4) naturally tends to return to its original length or position to relieve its induced strain. Referring still to FIG. 5 that shows the plurality of magnetically attractable members (5) in proximity relative to one another such that they cause the conformable member (4) to provide a spring-like tensioning force (8) to be imparted on the cigar (1).

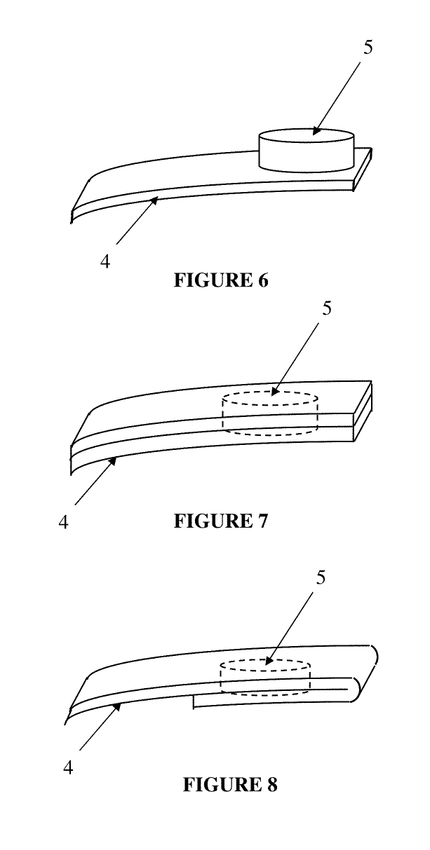

Referring now to FIG. 6 that shows one end of one embodiment of the present invention and shows a magnetically attractable member (5) at least partially exposed externally to conformable member (4) such that magnetically attractable member (5) is not completely enclosed within conformable member (4).

Referring now to FIGS. 7 and 8 that each show one end of one embodiment of the present invention and shows a magnetically attractable member (5) secured internally to conformable member (4) such that magnetically attractable member (5) is completely enclosed within conformable member (4).

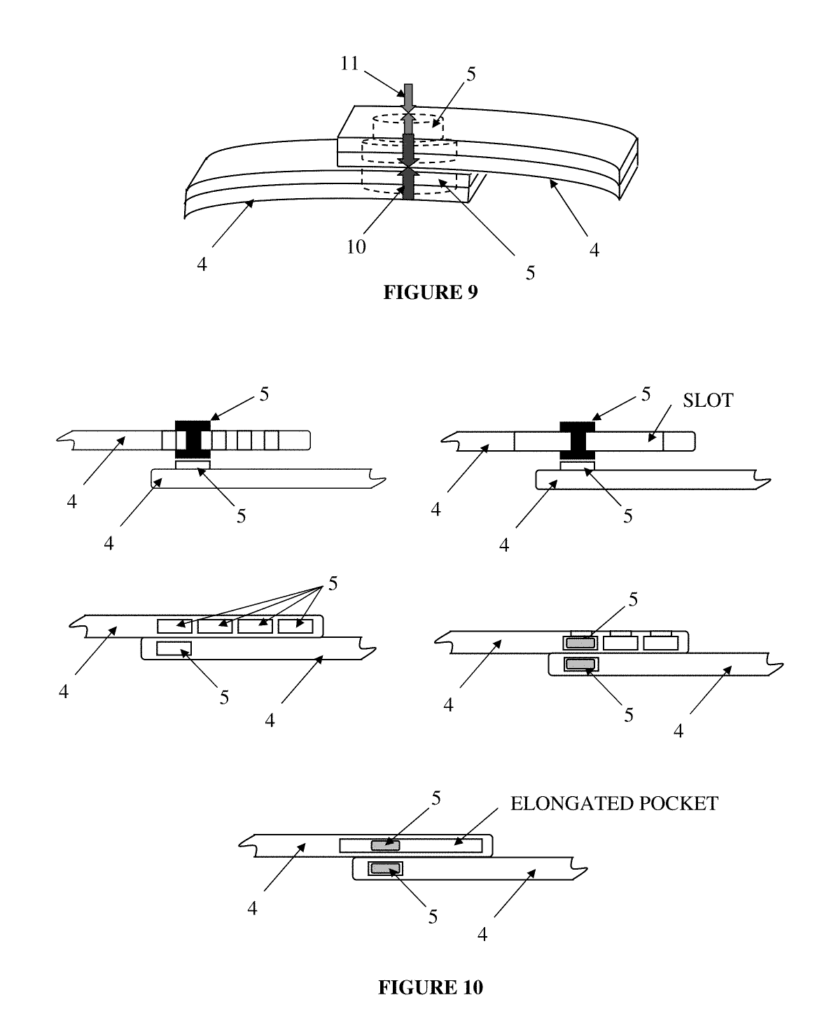

Referring now to FIG. 9 that shows the ends of one embodiment of the present invention with magnetically attractable members (5) each shaped to provide one magnetic attractive force (10) between magnetically attractable members (5) and a differing magnetic attractive force (11) with a separate magnetically attractable object (3) not part of the present invention.

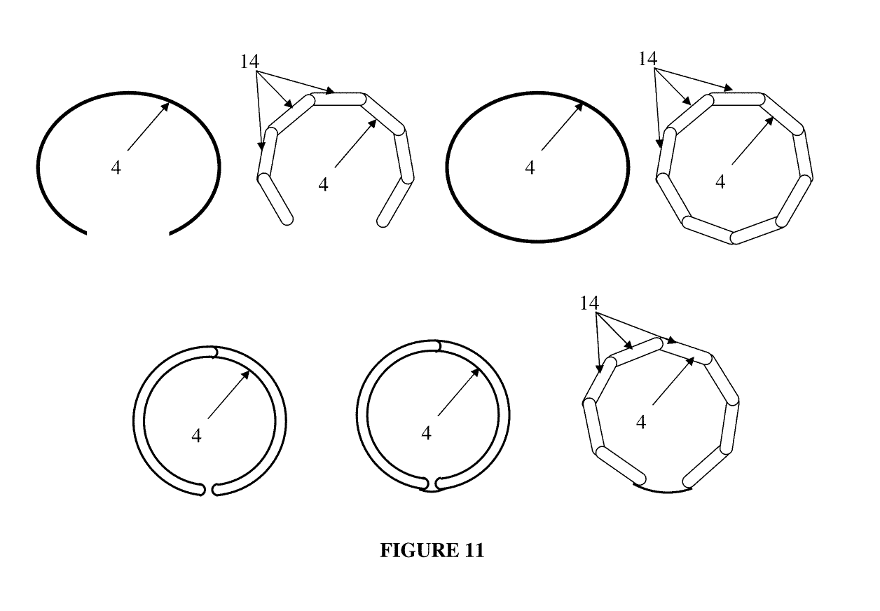

Referring now to FIG. 10 that shows the ends of multiple embodiments of the present invention with different methods of retaining magnetically attractable members (5) relative to conformable member (4), said method being changeable, alterable or adjustable. Referring still to FIG. 10, although multiple embodiments of changeable, alterable or adjustable retaining methods are illustrated, not all potential configurations and or embodiments of changeable, alterable or adjustable retaining methods are illustrated.

Referring now to FIG. 11 that shows multiple potential embodiments of conformable member (4) of the present invention. Referring still to FIG. 11 in which one embodiment of conformable member (4) is comprised of a flexible band of material such as leather, animal skin, reptile skin, cloth, nylon strap or any other type of flexible material or combination of materials, natural or manmade, that readily conforms to the circumference of the cigar (1). Referring still to FIG. 11 in which another embodiment of conformable member (4) is comprised a plurality of members (14) that are pivotally attached to one another and are free to pivot relative to one another such that they form a conformable member that readily conforms to the circumference of the cigar (1). Referring still to FIG. 11 in which another embodiment of conformable member (4) is comprised of a material (16) that has a spring-rate or has been designed, manufactured or formed in such a way to produce a spring rate such that as the material is pulled in tension to elongate and/or induce strain, the material naturally tends to return to its original length or position to relieve its induced strain. Referring still to FIG. 11 in which additional embodiments of conformable member (4) are comprised of a closed ring, loop, or band being fabricated such that the closed ring, loop, or band has a spring-rate or has been designed, manufactured or formed to produce a spring rate such that as the material is pulled in tension to elongate and/or induce strain, the material naturally tends to return to its original length or position to relieve its induced strain such that as it is expanded to place around the circumference of cigar (1), it provides a tensioning force (8) to be imparted onto the diameter of cigar (1) sufficient to retain the cigar (1).

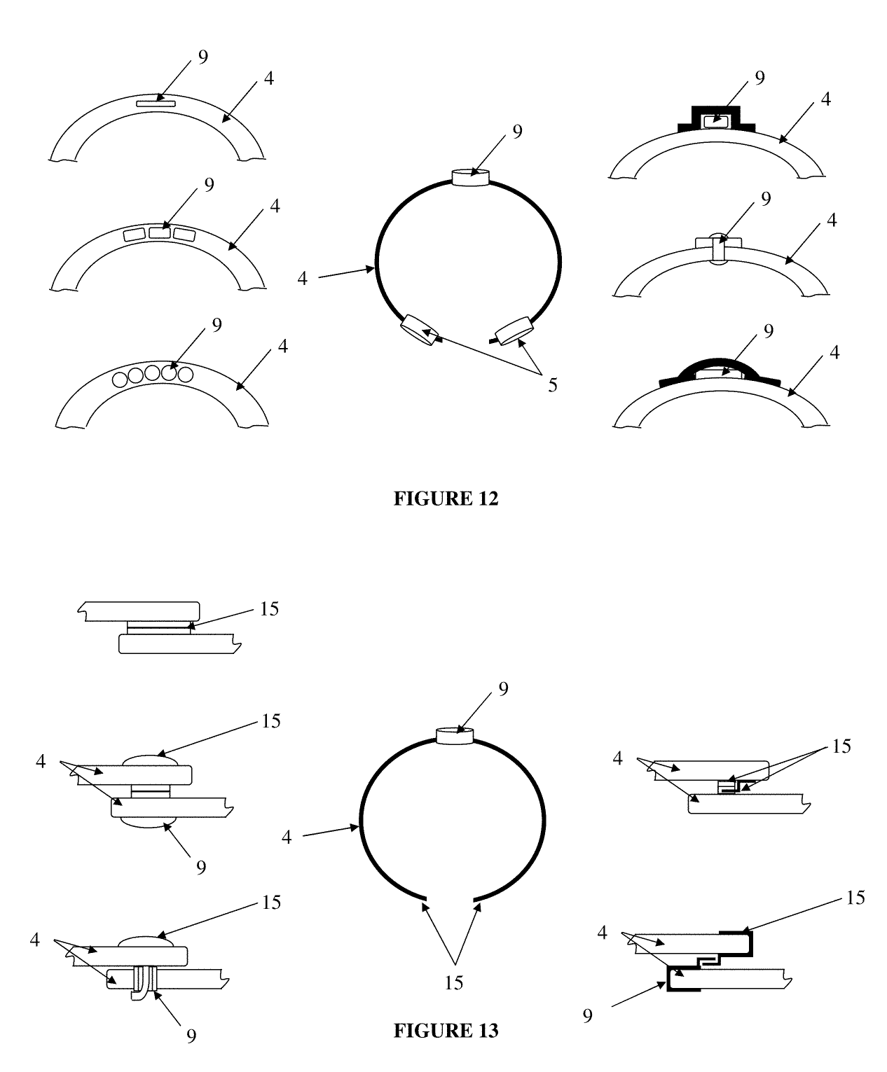

Referring now to FIG. 12 that shows one embodiment of the present invention with multiple potential embodiments of a magnetically attractable member (9) or a plurality of magnetically attractable members (9) that are attached to conformable member (4) for the purpose of removably attaching the cigar (1) to a separate magnetically attractable object (3) not part of the present invention.

Referring now to FIG. 13 that shows one embodiment of the present invention having conformable member (4) with mechanical means (15) such as snaps, ties, hook-and-loop, buckle, etc. for the purpose of securing conformable member (4) around the circumference of a cigar and with a magnetically attractable member (9) or a plurality of magnetically attractable members (9) attached to conformable member (4) for the purpose of removably attaching the cigar (1) to a separate magnetically attractable object (3), not part of the present invention. Referring still to FIG. 13 that additionally shows multiple examples of potential configurations of the embodiment but does not show all potential configurations of the embodiment.

The present invention removably attaches to a cigar (1) to provide a means of removably attaching the cigar (1) to a separate magnetically attractable object (3) not part of the present invention.

In one embodiment, conformable member (4) is placed around the circumference of a cigar (1) such that the proximity of the magnetically attractable members (5) relative to one another allows the magnetically attractable members (5) to be engaged, retaining cigar (1) within conformable member (4) and making the cigar removably attachable to a separate magnetically attractable object (3) not part of the present invention. In this embodiment, at least one of the magnetically attractable members (5) or the magnetically attractable object (3), not part of the present invention, must be comprised of a magnet.

In another embodiment, conformable member (4) is placed around the circumference of a cigar (1) such that the proximity of the magnetically attractable members (5a) relative to one another provides a spring-like tensioning force (8) to be imparted on the cigar (1) by the conformable member (4). The spring-like tensioning force (8) is provided by the magnetic attraction of the magnetically attractable members (5a), each of which is a magnet, tending to pull the magnetic poles (6) and (7) into alignment with one another. The spring-like tensioning force (8) allows the conformable member (4) to securely retain the cigar (1) within the conformable member (4) without damaging the integrity of the cigar (1). Prior art does not provide this feature by this means and can damage the integrity of the cigar (1) tobacco leaves that are in contact with the cigar retaining device either by piercing the cigar (1) or by mechanically clamping down on the cigar (1) in localized areas around the circumference of the cigar (1). The described embodiments of the present invention provide for the conformable member (4) to evenly distribute a gentle, spring-like tensioning force (8) around the circumference of the cigar (1), providing for a secure fit that does not damage the integrity of the cigar (1) tobacco leaves and provides for removably attaching the cigar (1) to a separate magnetically attractable object (3) not part of the present invention.

Other embodiments of the present invention provide for the spring-like tensioning force (8) by other means. In one embodiment, the spring-like tensioning force (8) can be provided by the material type and/or design and construction of the conformable member (4). In another embodiment, the spring-like tensioning force (8) can be provided by a combination of the proximity of the magnetically attractable members (5a) relative to one another and the material type and/or design and construction of the conformable member (4). Each of these embodiments provides for the conformable member (4) to gently and evenly distribute the spring-like tensioning force (8) around the circumference of the cigar (1), providing for a secure fit that does not damage the integrity of the cigar (1) tobacco leaves and provides for removably attaching the cigar (1) to a separate magnetically attractable object (3) not part of the present invention.

In another embodiment of the present invention, conformable member (4) is placed around the circumference of a cigar (1) such that the proximity of the magnetically attractable members (5) relative to one another does not provide a spring-like tensioning force (8) to be imparted on the cigar (1) by the conformable member (4), but instead provides for fixed engagement of magnetically attractable members (5) such that they are removably attached in a fixed position creating sufficient tension to be imparted on conformable member (4) to securely retain the cigar (1) within the conformable member (4) without damaging the integrity of the cigar (1). In another embodiment, a spring-like tensioning force (8) can be provided by the material type and/or design and construction of the conformable member (4). Each of these embodiments provides for the conformable member (4) to gently and evenly distribute a tensioning force (8) around the circumference of the cigar (1), providing for a secure fit that does not damage the integrity of the cigar (1) tobacco leaves and provides for removably attaching the cigar (1) to a separate magnetically attractable object (3) not part of the present invention.

Whether utilizing magnetically attractable members (5) to create a spring-like tensioning force (8) or utilizing magnetically attractable members (5) to create a fixed engagement in a fixed position relative to one another, there are many possible variations of the magnetically attractable members (5) creating many different embodiments of the current invention, each of which provides for the conformable member (4) to gently and evenly distribute a tensioning force (8) around the circumference of the cigar (I), providing for a secure fit that does not damage the integrity of the cigar (1) tobacco leaves and provides for removably attaching the cigar (1) to a separate magnetically attractable object (3) not part of the present invention. In one embodiment, magnetically attractable member (5a) is comprised of a magnet and magnetically attractable member (5b) is not comprised of a magnet, but of some magnetically attractable material such that as conformable member (4) is placed around the circumference of a cigar (1), the proximity of the magnetically attractable members (5a) and (5b) relative to one another is such that they engage and are removably attached creating sufficient tensioning force (8) to be imparted on conformable member (4) to securely retain the cigar (1) within the conformable member (4) without damaging the integrity of the cigar (1) and provides for removably attaching the cigar (1) to a separate magnetically attractable object (3) not part of the present invention.

In yet another embodiment, the present invention consists of a conformable member (4) that is formed or fabricated with a different mechanical means of securing conformable member (4) around the circumference of the cigar (1), said means not necessarily being magnetically attractable, such as leather straps, ties, fabric, plastic snaps, hook-and-loop, etc. providing for the conformable member (4) to evenly distribute a tensioning force (8) around the circumference of the cigar (1), providing for a secure fit that does not damage the integrity of the cigar (1) tobacco leaves. This embodiment may utilize a magnetically attractable mechanical means of securing conformable member (4) around the circumference of the cigar (1) or may instead utilize a separate magnetically attractable member (9) attached to conformable member (4) for the purpose of removably attaching the cigar (1) to a separate magnetically attractable object (3) not part of the present invention.

There are many possible variations of the conformable member (4) creating many different embodiments of the current invention, each of which provides for the conformable member (4) to evenly distribute a tensioning force (8) around the circumference of the cigar (1), providing for a secure fit that does not damage the integrity of the cigar (1) tobacco leaves. In one embodiment, the conformable member (4) is comprised of a flexible band of material such as leather, animal skin, reptile skin, cloth, nylon strap or any other type of flexible material or combination of materials, natural or manmade, that readily conforms to the circumference of the cigar (1). In another embodiment, the conformable member (4) is comprised of a plurality of pivotally attached members that are free to pivot relative to one another such that they form a conformable member that readily conforms to the circumference of the cigar (1). In yet another embodiment, the conformable member (4) is comprised of a elastic material (16) such as rubber, that has a spring-rate or has been manufactured or formed to produce a spring rate such that as the material is pulled in tension to elongate and/or induce strain, the material naturally tends to return to its original length or position to relieve its induced strain.

Although detailed descriptions of a limited number of embodiments and applications have been disclosed, it is understood that other embodiments and other applications of the invention are possible and that various orientations, changes, substitutions, and/or modifications of the described embodiments are possible without departing from the spirit of the invention.

What is claimed is:

1. A device and method for removably attaching a cigar to a magnetically attractable object, said device comprising:
a. a conformable member that can be placed relative to the circumference of a cigar and
b. a plurality of magnetically attractable members positioned relative to the conformable member such that when the conformable member is positioned relative to the circumference of the cigar, the magnetically attractable members cause the conformable member to be removably secured relative to the cigar.

2. The device of claim 1 wherein the position of the magnetically attractable members relative to the conformable member cause the conformable member to be removably secured relative to the cigar such that the proximity of the magnetically attractable members relative to one another provides a spring-like tensioning force to be imparted on the cigar by the conformable member.

3. The device of claim 1 wherein the design and/or construction of the conformable member provides a spring-like tensioning force to be imparted on the cigar by the conformable member.

4. The device of claim 1 wherein the position of at least one of the magnetically attractable members relative to the conformable member is changeable, alterable or adjustable.

5. The device of claim 1 wherein at least one of the magnetically attractable members is secured to the conformable member such that the magnetically attractable member is at least partially exposed externally to the conformable member and is not completely enclosed within the conformable member.

6. The device of claim 1 wherein at least one of the magnetically attractable members is secured internally to the conformable member such that the magnetically attractable member is completely enclosed within the conformable member.

7. The device of claim 1 wherein at least one of the magnetically attractable members is shaped to provide one magnetic attractive force between the magnetically attractable members and a differing magnetic attractive force with a magnetically attractable object not part of the present invention.

8. The device of claim 1 wherein at least one of the magnetically attractable members is positioned and/or oriented to provide one magnetic attractive force between the magnetically attractable members and a differing magnetic attractive force with a magnetically attractable object not part of the present invention.

9. The device of claim 1 wherein the conformable member comprises a flexible band of material such as leather, animal skin, reptile skin, cloth, nylon strap or any other type of flexible material or combination of materials, natural or manmade, that readily conforms to the circumference of a cigar.

10. The device of claim 1 wherein the conformable member is comprised of a plurality of members that are pivotally attached to one another and are free to pivot relative to one another such that they form a conformable member that readily conforms to the circumference of a cigar.

11. The device of claim 1 wherein the conformable member is comprised of a material that has a spring-rate or has been manufactured or formed to produce a spring rate such that as the material is pulled in tension to elongate and/or induce strain, the material naturally tends to return to its original length or position to relieve its induced strain.

12. The device of claim 1 wherein an additional magnetically attractable member or a plurality of additional magnetically attractable members is attached to the conformable member for the purpose of removably attaching the cigar to a magnetically attractable object.

13. A device and method for removably attaching a cigar to a magnetically attractable object, said device comprising:
a. a conformable member that can be placed relative to the circumference of a cigar,
b. a mechanical means of securing the conformable member to the cigar, said means not necessarily being separate and/or distinct from the conformable member, and
c. at least one magnetically attractable member, said member not necessarily being separate and/or distinct from the conformable member and said member not necessarily being separate and/or distinct from the mechanical means of securing the conformable member, for the purpose of removably attaching the cigar to a magnetically attractable object.

14. The device of claim 13 wherein the design and/or construction of the conformable member provides a spring-like tensioning force to be imparted on the cigar by the conformable member.

15. The device of claim 13 wherein the position of at least one of the magnetically attractable members relative to the conformable member is changeable, alterable or adjustable.

16. The device of claim 13 wherein at least one of the magnetically attractable members is secured to the conformable member such that the magnetically attractable member is at least partially exposed externally to the conformable member and is not completely enclosed within the conformable member.

17. The device of claim 13 wherein at least one of the magnetically attractable members is secured internally to the conformable member such that the magnetically attractable member is completely enclosed within the conformable member.

18. The device of claim 13 wherein the conformable member comprises a flexible band of material such as leather, animal skin, reptile skin, cloth, nylon strap or any other type of flexible material or combination of materials, natural or manmade, that readily conforms to the circumference of a cigar.

19. The device of claim 13 wherein the conformable member is comprised of a plurality of members that are pivotally attached to one another and are free to pivot relative to one another such that they form a conformable member that readily conforms to the circumference of a cigar.

20. The device of claim 13 wherein the conformable member is comprised of a material that has a spring-rate or has been manufactured or formed to produce a spring rate such that as the material is pulled in tension to elongate and/or induce strain, the material naturally tends to return to its original length or position to relieve its induced strain.

21. The device of claim 13 wherein the conformable member is formed as a closed ring, loop, or band.
